(19) United States
(12) Patent Application Publication
(10) Pub. No.: US 2026/0079608 A1
(43) Pub. Date: Mar. 19, 2026

(54) INFORMATION PROCESSING APPARATUS FOR CONTROLLING SHOOTING IN METAVERSE SPACE, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: KOHEI SHOGOME, Kanagawa (JP)

(21) Appl. No.: 19/326,531

(22) Filed: Sep. 11, 2025

(30) Foreign Application Priority Data
Sep. 17, 2024 (JP) 2024-159969

(51) Int. Cl. G06F 3/04815; G06T 19/00

(52) U.S. Cl. CPC G06F 3/04815; G06T 19/006; G06T 2219/2004

(57) ABSTRACT

An information processing apparatus that can reliably transmit an instruction about a composition of shooting in a metaverse space from a shooting user to an object user. The information processing apparatus includes a memory device that stores a set of instructions, and at least one processor that executes the set of instructions to allow a shooting user to set a target object user to be a target of a composition instruction from among one or more object user in shooting in a metaverse space, allow the shooting user to set a standing position of an avatar of the target object user in the metaverse space, and display a first mark at the standing position in the metaverse space that is visible to the shooting user and the target object user on their respective display units so as not to be shot in a shot image in the metaverse space.

### BACKGROUND

### Field of the Technology

The aspect of the embodiments relates to an information processing apparatus for controlling shooting in a metaverse space, a control method therefor, and a storage medium storing a control program therefor.

### Description of the Related Art

In recent years, technological innovation of virtual reality (hereinafter referred to as “VR”) has been remarkable. In addition, with the technological innovation, a VR device such as a head mounted display (hereinafter referred to as an “HMD”) has become widespread, and communications between users in a virtual space of the VR have been activated. Such a form of an application for a purpose of communication is called a metaverse.

In a virtual space of the metaverse (hereinafter referred to as a “metaverse space”), a user can communicate with another user using an avatar that is an alter ego of the user. As the communication with another user, for example, there is shooting of an avatar as an object. In this regard, the avatar can more faithfully reproduce a body motion of the user because of progress of tracking technologies such as eye tracking for tracking an eye-gaze of a user and body tracking for tracking an entire body of a user. Therefore, in the shooting in the metaverse space, expressiveness can be greatly improved by correctly reflecting the eye-gaze and the pose of the user detected by these tracking techniques on the avatar of the user.

In view of such a background, it is considered that the activity of shooting in the metaverse space evolves in a direction of pursuing artistic quality. However, even if a body motion of a user as an object (hereinafter referred to as an “object user”) can be reflected on an avatar of the object user as-is, it is not always possible to perform shooting as intended a user as a shooter (hereinafter referred to as a “shooting user”). That is, unlike shooting in the actual space, in the shooting in the metaverse space, there is a tendency that a case where a shot image is different from an intended composition because an intention of the shooting user is not well transmitted to the object user occurs.

As a technique related to this, for example, Japanese Patent Laid-Open No. 2022-114600 (JP2022-114600A) discloses an image shooting system in which an object person wearing AR goggles is shot by a camera. In the image shooting system disclosed in the publication, a relative positional relationship between the AR goggles and the camera is specified by recognizing an image shot by the camera for a live view. Further, the live view is displayed on a display of the AR goggles so that the person is looking toward the camera. Accordingly, the person wearing the AR goggles can check the state of his/her image in the live view while maintaining the camera-directed gaze.

However, the image shooting system disclosed in the above publication is the technique predicated on the camera-directed gaze, and cannot be applied to shooting in the metaverse space in a case where the shooting user does not expect that case. In addition, the image shooting system disclosed in the above publication cannot control elements, such as a standing position and a pose of an avatar of the object user, that greatly affect the composition of the shooting in the metaverse space.

### SUMMARY

The present disclosure provides an information processing apparatus, a control method therefor, and a storage medium storing a control program therefor, which can reliably transmit an instruction about a composition of shooting in a metaverse space from a shooting user to an object user.

Accordingly, an aspect of the embodiments provides an information processing apparatus including a memory device that stores a set of instructions, and at least one processor that executes the set of instructions to allow a shooting user to set a target object user to be a target of a composition instruction from among one or more object user in shooting in a metaverse space, allow the shooting user to set a standing position of an avatar of the target object user in the metaverse space, and display a first mark at the standing position in the metaverse space that is visible to the shooting user and the target object user on their respective display units so as not to be shot in a shot image in the metaverse space.

Features of the present disclosure will become apparent from the following description of embodiments with reference to the attached drawings. The following description of embodiments is described by way of example.

### BRIEF DESCRIPTION OF THE DRAWINGS

FIGS. 1A, 1B, 1C, and 1D are image diagrams for describing shooting in a metaverse space.

FIG. 2 is a block diagram illustrating an example of a hardware configuration of an HMD.

FIG. 3 is a block diagram illustrating an example of a functional configuration of the HMD.

FIG. 4 is a flowchart illustrating a process in issuing an instruction about a composition (a composition instruction) from a shooting user to an object user in shooting in the metaverse space.

FIG. 5 is a view illustrating a GUI used when the shooting user selects a target of the composition instruction from among object users.

FIG. 6 is a view illustrating a standing position in the metaverse space that the shooting user expects for an avatar of the object user selected as the target of the composition instruction from a viewpoint of the shooting user.

FIG. 7 is a view illustrating a line-of-sight position in the metaverse space that the shooting user expects for the avatar of the object user selected as the target of the composition instruction from the viewpoint of the shooting user.

FIG. 8 is a view illustrating a pose object from a viewpoint of a third party.

FIG. 9 is a view illustrating a visual field of the object user when the composition instruction is issued.

FIG. 10 is a view illustrating a visual field of the object user when an object avatar moves to the standing position and faces a live view.

FIG. 11 is a flowchart illustrating a process in adjusting positions of standing position marks and live views.

FIG. 12A is a view illustrating the metaverse space when the shooting user selects a position adjustment target from among the standing position marks and the live views from the viewpoint of the shooting user.

FIG. 12B is a view illustrating a controller operated when the shooting user selects a position adjustment target from among the standing position marks and the live views.

FIG. 13 is a view for describing adjustment of the position of the live view selected as the target of the position adjustment.

FIG. 14 is a flowchart illustrating a process in displaying the line-of-sight of the object avatar.

FIG. 15 is a view illustrating the metaverse space in which the line-of-sight of the object avatar is displayed from the viewpoint of the shooting user.

### DESCRIPTION OF THE EMBODIMENTS

Hereinafter, embodiments of the present disclosure will be described in detail with reference to the attached drawings. However, the configurations described in the following embodiments are merely examples, and the scope of the present disclosure is not limited by the configurations described in the embodiments. For example, each of the units constituting the present disclosure can be replaced with any unit that can exhibit the same function. In addition, an arbitrary constituent may be added. Any two or more configurations (features) of the embodiments can be combined. In addition, all combinations of features described in each embodiment are not necessarily essential to the solution of the present disclosure. In addition, the features of each embodiment can be modified or changed as appropriate depending on the specifications of the apparatus to which the present disclosure is applied and various conditions (use conditions, use environment, etc.).

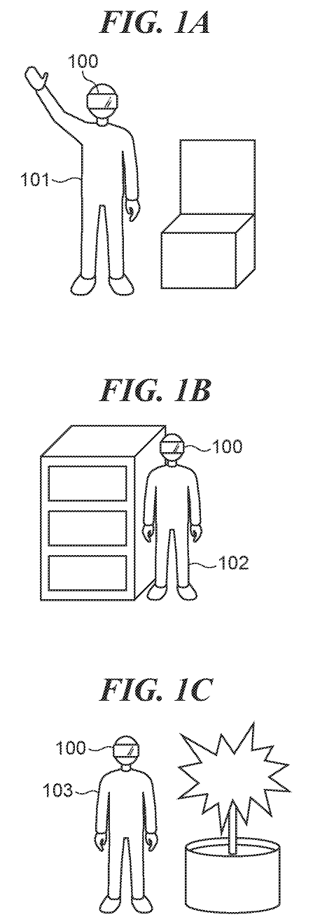

Hereinafter, a first embodiment will be described with reference to FIGS. 1A to 10. In the first embodiment, an example of shooting in a metaverse space will be described. FIGS. 1A to 1D are image diagrams for describing shooting in the metaverse space. FIGS. 1A to 1C illustrate a real space, and FIG. 1D illustrates the metaverse space. In FIGS. 1A to 1C, metaverse users 101 to 103 are wearing full-immersion HMDs 100 (information processing apparatuses) and are in physically different real spaces.

In the first embodiment, the users 101 and 102 are described as object users, and the user 103 is described as a shooting user. The users 101 to 103 can arbitrarily replace roles of the object user and the shooting user. Hereinafter, when the users 101 to 103 are described while specifying the roles of the object user and the shooting user, the user 101 is described as the “object user 101”, the user 102 is described as the “object user 102”, and the user 103 is described as the “shooting user 103”. Note that objects of shooting in the metaverse space are not limited to two persons of users 101 and 102, and may be three or more persons.

FIG. 1D shows avatars 104 to 106 in the metaverse space. The avatar 104 is an alter ego of the object user 101, the avatar 105 is an alter ego of the object user 102, and the avatar 106 is an alter ego of the shooting user 103. Hereinafter, when the avatar 104 is described by specifying the role of the object, the avatar 104 may be described as an “object avatar 104”. In addition, when the avatars 105 and 106 are described by specifying the roles of the object and the shooter, the avatar 105 is described as an “object avatar 105” and the avatar 106 is described as a “shooter avatar 106”.

A camera object 107 is a 3DCG object of a camera. In the shooting in the metaverse space, a position and a direction of a lens of the camera object 107 define a shooting position and a shooting direction. The camera object 107 can be visually recognized from the users 101 to 103, and is arranged for causing the object users 101 and 102 to recognize from where an image is shot, and improving immersion feeling and presence of the shooting in the metaverse space.

Standing position marks 108 and 109 (first marks) cause the object users 101 and 102 to confirm their own standing positions at the time of shooting and are displayed as CG objects on a floor surface of the metaverse space. The shooting user 103 determines the positions of the standing position marks 108 and 109. The object user 101 can visually recognize only the own standing position mark 108. Similarly, the object user 102 can visually recognize only the own standing position mark 109. On the other hand, the shooting user 103 can visually recognize the standing position marks 108 and 109. The standing position marks 108 and 109 are not shown in an image shot by the shooting user 103 in the metaverse space (hereinafter, referred to as a “shot image”). Further, display objects that the users 101 to 103 can visually recognize may be used instead of the standing position marks 108 and 109.

Live views 110 and 111 (second marks) are displayed for the object users 101 and 102 to check how well their own object avatars 104 and 105 are shot. The live views 110 and 111 are displayed as plate-shaped CG objects in the air of the metaverse space. A real-time image from the camera object 107, that is, a real-time image shot in the metaverse space is pasted as a texture on each the live views 110 and 111. The shooting user 103 determines the positions of the live views 110 and 111. The object user 101 can visually recognize the own live view 110 only. Similarly, the object user 102 can visually recognize the own live view 111 only. On the other hand, the shooting user 103 can visually recognize the live views 110 and 111. However, the shooting user 103 may switch between displaying and hiding of the live views 110 and 111. Note that the live views 110 and 111 are not shown in the shot image. Further, display objects that the users 101 to 103 can visually recognize may be used instead of the live views 110 and 111.

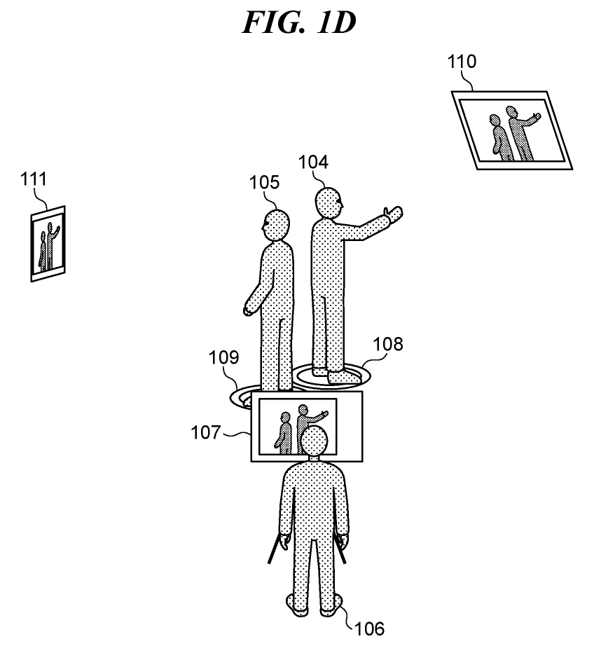

FIG. 2 is a block diagram illustrating an example of a hardware configuration of the HMD 100. The HMD 100 includes a main unit 201 and a controller 202. Each of the users 101 to 103 wears the main unit 201 of the HMD 100 on the head and holds the controller 202 connected to the main unit 201 by a wired or wireless connection. First, the main unit 201 will be described. A CPU 211 (computer) is a system controller and controls the entire HMD 100. The CPU 211 achieves an information process of the first embodiment by executing an information processing program. A ROM 212 is a read-only memory in which various programs and parameters that do not need to be changed, such as a basic program and initial data, are stored. A RAM 213 is a memory to temporarily store input information, calculation results of the information process and an image process. A sensor 214 is a sensing component, such as a gyro or an IMU, that detects a position and a posture of the main unit 201.

The input/output I/F 215 accepts input and output of required data. The required data includes input information, haptics information, and position-and-posture information of the controller 202 connected to the main unit 201. An input/output connection configuration of the input/output I/F 215 includes both a local connection by USB or Bluetooth (registered trademark) and Internet connection by Ethernet (registered trademark) or Wi-Fi (registered trademark). These points are also the same for an input/output I/F 222 of the controller 202 described later. The HMD 100 can control the display of the metaverse space in another HMD 100 via its input/output I/F 215. At this time, the HMD 100 performs input/output of information with another HMD 100 via the input/output I/F 215. The HMD 100 may control the display of the metaverse space in another HMD 100 through an external computer (not shown) that is connected via the input/output I/F 215.

A storage unit 216 is a device capable of writing and reading data. Specifically, the storage unit 216 is a hard disk or a memory card incorporated in or externally attached to the main unit 201, or a memory card, a removable disk, or an IC card that is attachable to and detachable from the main unit 201. The information processing program executed by the CPU 211 is recorded in the storage unit 216. The information processing program may be stored in the ROM 212. In addition, required data used when the information processing program is executed by the CPU 211 is recorded in the storage unit 216. Further, a shot image is also recorded in the storage unit 216.

A shooting unit 217 includes a plurality of cameras mounted on the main unit 201 so as to enable body tracking and eye tracking of a person who wears the main unit 201. A shot image obtained by the shooting unit 217 is subjected to image recognition, and a recognition result is used for tracking a whole body motion of the person wearing the main unit 201 and detecting a plane on which a virtual object such as a chair or a table will be superimposed. A display unit 218 is an electronic display mounted on the main unit 201. The display unit 218 is configured as a stereo display corresponding to both eyes of a person wearing the main unit 201. An operation unit 219 controls input to the main unit 201. The operation unit 219 includes a power button, a menu button, a selection button, an OK button, and the like as input members of the main unit 201. All the hardware configuration components of the main unit 201 are connected to a bus 220, and thus can communicate with each other.

Next, the controller 202 will be described. A sensor 221 is a sensing component such as a gyro or an IMU that detects a position and a posture of the controller 202. The input/output I/F 222 accepts input/output of required data. An operation unit 223 controls input to the controller 202. The operation unit 223 includes a power button, a menu button, a selection button, an OK button, a track pad, a thumb stick, and the like as input members of the controller 202. A vibrator 224 is a vibration device that controls vibration of the controller 202 on the basis of the haptics information transmitted from the main unit 201. That is, the vibrator 224 vibrates in conjunction with an input result. All hardware configuration components of the controller 202 are connected to a bus 225 and are communicable to each other.

In a case where the HMD 100 is reduced in size and weight, the shooting-and-displaying system and the processing system of the HMD 100 may be separated. In such a case, the shooting-and-displaying system may be disposed in the HMD 100, and the processing system may be disposed in a small external box computer as an external configuration. Further, a part of the imaging system (camera for body tracking) in the HMD 100 may be separated and disposed independently from the HMD100 or a small external box computer. In such a configuration, the small external box computer corresponds to the information processing apparatus. The external apparatus is not limited to the small external box computer, and may be, for example, a portable computer such as a notebook PC, a tablet PC, or a smartphone, or a stationary computer such as a desktop PC.

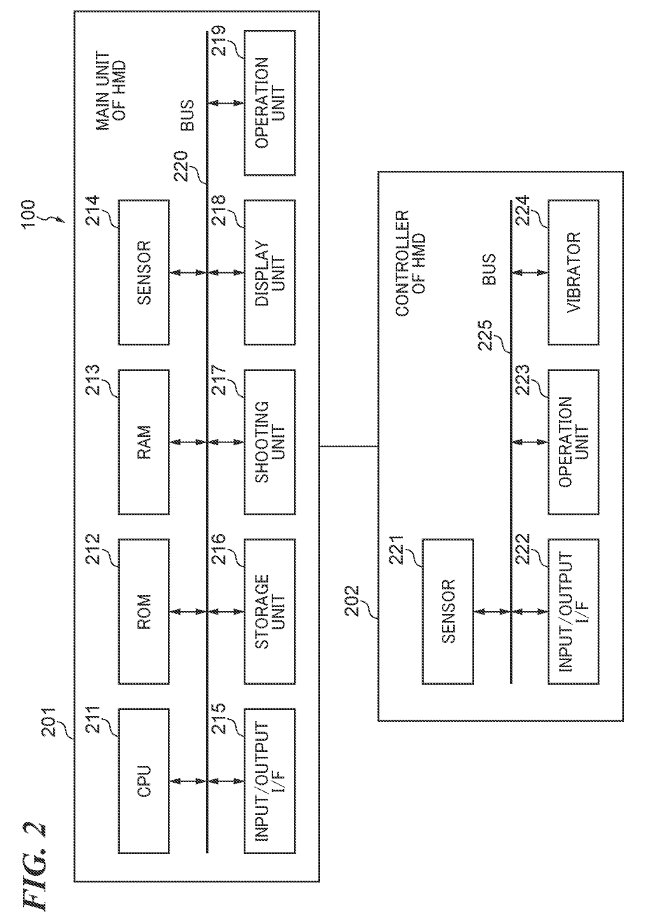

FIG. 3 is a block diagram illustrating an example of a functional configuration of the HMD 100. Here, an integrated configuration of all the functions shown in FIG. 3 is referred to as a composition instruction support system 300. The composition instruction support system 300 includes an object setting unit 301 (a first target setting unit), a standing position setting unit 302 (a first position setting unit), and a mark display unit 303 (a first display module). The composition instruction support system 300 further includes a line-of-sight setting unit 304 (a second position setting unit), a live view display unit 305 (a second display unit), a shooter pose detection unit 306 (a first detection unit), and a model pose display unit 307 (a third display unit). The composition instruction support system 300 further includes a mark/live-view setting unit 308 (a second target setting unit) and a mark/live-view adjustment unit 309 (a position adjustment unit). The composition instruction support system 300 further includes an object line-of-sight detection unit 310 (a second detection unit) and an object line-of-sight display unit 311 (a fourth display unit).

The object setting unit 301 allows the shooting user 103 to select a target to which an instruction about composition (a composition instruction) is sent from among the object users 101 and 102, and sets the target to the composition instruction support system 300. Hereinafter, a case where the object user 101 is set as the target by the object setting unit 301 will be described as an example. The standing position setting unit 302 allows the shooting user 103 to set, to the composition instruction support system 300, a standing position expected for the avatar 104 of the object user 101 set by the object setting unit 301 in the metaverse space. The mark display unit 303 displays the standing position mark 108 at the standing position in the metaverse space set by the standing position setting unit 302.

The line-of-sight setting unit 304 allows the shooting user 103 to set, to the composition instruction support system 300, a line-of-sight position in the metaverse space expected for the avatar 104 of the object user 101 set by the object setting unit 301. The live view display unit 305 displays the live view 110 at the line-of-sight position in the metaverse space set by the line-of-sight setting unit 304. Although the case where object user 101 is set by the object setting unit 301 has been described above, the standing position mark 109 and the live view 111 are displayed in the same manner in a case where the object user 101 is set by the object setting unit 301.

The shooter pose detection unit 306 detects the whole body pose (hereinafter referred to as a “pose”) of the shooting user 103 and sets the pose to the composition instruction support system 300. Specifically, the pose is detected by body tracking using a plurality of cameras mounted on the main unit 201 of the HMD 100 or body tracking using dedicated devices attached to limbs of the shooting user 103. The model pose display unit 307 generates a pose object of the 3DCG based on the pose of the shooting user 103 set by the shooter pose detection unit 306 and displays the pose object in the metaverse space.

The mark/live-view setting unit 308 allows the shooting user 103 to set, to the composition instruction support system 300, a target whose position is adjusted among the standing position marks 108 and 109 and the live views 110 and 111. Hereinafter, the target whose position is adjusted is referred to as a “position adjustment target”. The mark/live-view adjustment unit 309 adjusts the position of the position adjustment target set by the mark/live-view setting unit 308 in vertical and horizontal directions. Further, the mark/live-view adjustment unit 309 sets the adjusted position of the position adjustment target to the composition instruction support system 300.

The object line-of-sight detection unit 310 detects the line-of-sights of the object avatars 104 and 105. Further, the object line-of-sight detection unit 310 sets the detected line-of-sights of the object avatars 104 and 105 to the composition instruction support system 300. The object line-of-sight display unit 311 displays the line-of-sights of the object avatars 104 and 105 detected by the object line-of-sight detection unit 310 in the metaverse space as the 3DCG objects so that the shooting user 103 can visually recognize the line-of-sights.

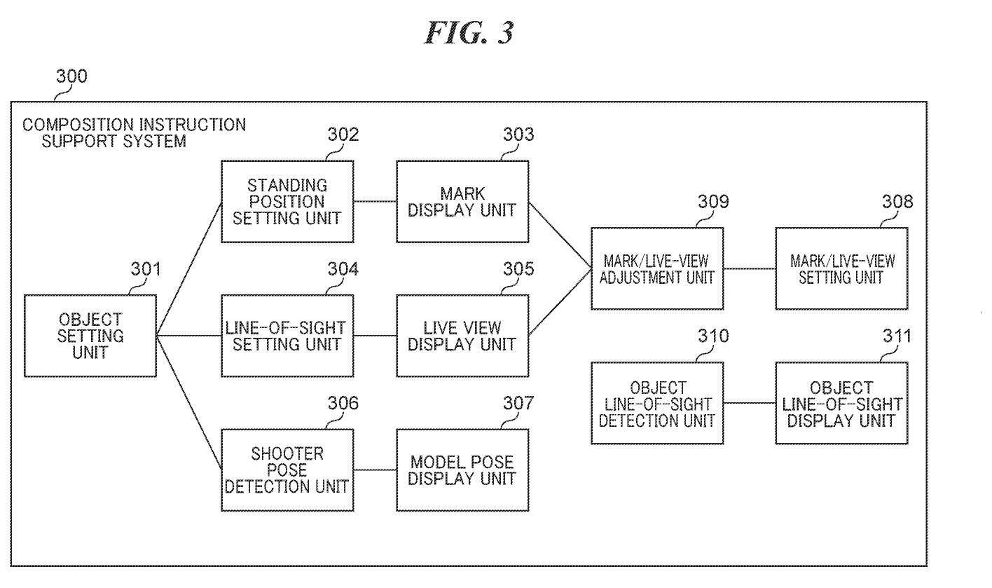

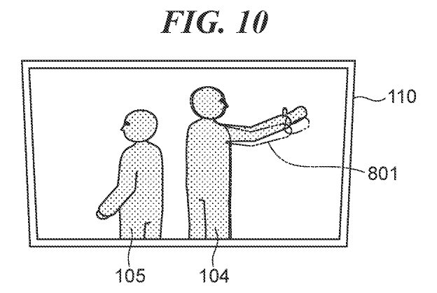

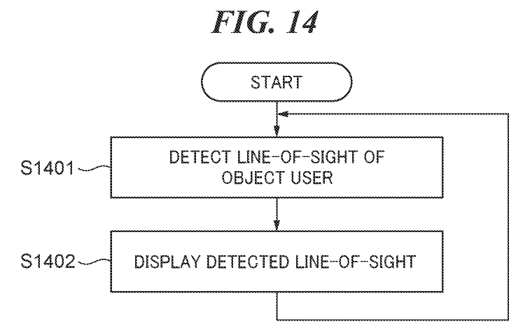

Next, a case where the shooting user 103 issues a composition instruction to the object users 101 and 102 in shooting in the metaverse space will be described. FIG. 4 is a flowchart illustrating a process in issuing the composition instruction from the shooting user 103 to the object users 101 and 102 in shooting in the metaverse space. The flowchart in FIG. 4 (a control method for the information processing apparatus) is achieved by the CPU 211 reading an information processing program (a program) stored in the storage unit 216, developing it onto the RAM 213, and executing it in the HMD 100 of the shooting user 103. This point is also the same for flowcharts (control methods for the information processing apparatus) illustrated in FIGS. 11 and 14 described later. The flowchart in FIG. 4 is started by a trigger when the shooting user 103 selects issuance of the composition instruction to the object users 101 and 102 by a GUI operation.

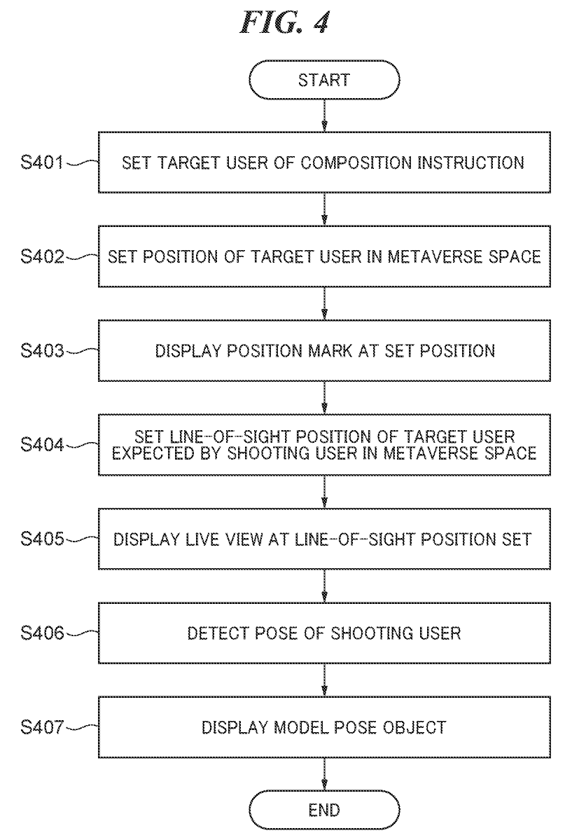

In a step S401, the CPU 211 sets the target of the composition instruction selected by the shooting user 103 from among the object users 101 and 102 to the composition instruction support system 300 by the object setting unit 301 (a first target setting step). FIG. 5 is a view illustrating a GUI used when the shooting user 103 selects a target of the composition instruction from among the object users 101 and 102. The GUI illustrated in FIG. 5 is displayed on the display unit 218 of the main unit 201 of the HMD 100 of the shooting user 103. In the GUI illustrated in FIG. 5, an icon 501 indicating the object user 101 (user A) and an icon 502 indicating the object user 102 (user B) are displayed.

The shooting user 103 selects the object user 101 or 102 by designating one of the icons 501 and 502 through a GUI operation with the controller 202. In the case of FIG. 5, since the shooting user 103 designates the icon 501 by putting a focus frame on the icon 501 indicating the object user 101 (user A), the object user 101 is selected. When the shooting user 103 presses the OK button of the controller 202 in this state, the object user 101 is set as the target of the composition instruction. Note that the shooting user 103 can move the focus frame to the icon 502 indicating the object user 102 (user B) by a tilting operation of the thumb stick of the controller 202.

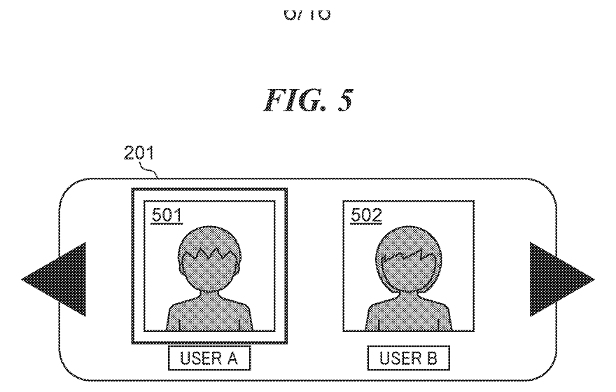

Returning to the description of FIG. 5. In the following, the case where the object setting unit 301 sets the object user 101 as the target of the composition instruction to the composition instruction support system 300 in the step S401 will be described as an example. The same is applicable to a case where the object user 102 is set. In a step S402, the CPU 211 sets the standing position of the avatar 104 of the object user 101 who is the target of the composition instruction in the metaverse space expected by the shooting user 103 to the composition instruction support system 300 by the standing position setting unit 302. That is, the step S402 corresponds to a first position setting step. FIG. 6 is a view illustrating, from the viewpoint of the shooting user 103, a standing position 601 in the metaverse space that the shooting user 103 expects for the avatar 104 of the object user 101 who is the target of the composition instruction (hereinafter, abbreviated as a “standing position 601”).

The standing position setting unit 302 displays a floor surface object 602 clearly indicating a floor surface of the metaverse space. The standing position setting unit 302 also specifies an intersection of a light-ray object 603 irradiated from the controller 202 of the shooting user 103 and the floor surface object 602. Further, the standing position setting unit 302 sets the specified intersection as the standing position 601 to the composition instruction support system 300. In this manner, the shooting user 103 can determine the standing position 601 by specifying one location in the metaverse space. The irradiation direction of the light-ray object 603 is determined based on the position-and-posture information about the controller 202 of the shooting user 103. The floor surface object 602 and the light-ray object 603 are visible only to the shooting user 103 and are not visible in the shot image.

Returning to the description of FIG. 4. In a step S403, the CPU 211 displays the standing position mark 108 at the standing position 601 set in the step S402 by the mark display unit 303 (a first display step). Specifically, as illustrated in FIG. 6, the standing position mark 108 is displayed in the metaverse space. At this time, the standing position mark 108 is visible only to the object user 101 and the shooting user 103 as described above. The mark display unit 303 may display a user name of the object user 101 who is the target of the composition instruction in the vicinity of the standing position mark 108 in the visual field of the shooting user 103 so as not to be shot in the shot image. Accordingly, the shooting user 103 can easily recognize that the standing position mark 108 is displayed due to the composition instruction to the object user 101. The mark display unit 303 may move the standing position mark 108 in conjunction with a change in the irradiation direction of the light-ray object 603.

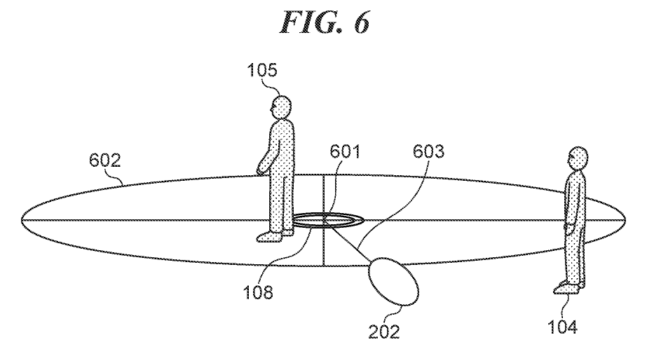

Returning to the description of FIG. 4. In a step S404, the CPU 211 sets the line-of-sight position in the metaverse space that the shooting user 103 expects for the avatar 104 of the object user 101 who is the target of the composition instruction to the composition instruction support system 300 by the line-of-sight setting unit 304. That is, the step S404 corresponds to a second position setting step. FIG. 7 is a view illustrating, from the viewpoint of the shooting user 103, a line-of-sight position 701 in the metaverse space that the shooting user 103 expects for the avatar 104 of the object user 101 who is the target of the composition instruction (hereinafter, abbreviated as a “line-of-sight position 701”).

The line-of-sight setting unit 304 displays a hemispherical object 702 centered around the standing position 601 set in the step S402. The line-of-sight setting unit 304 specifies an intersection of the light-ray object 603 irradiated from the controller 202 of the shooting user 103 and the hemispherical object 702. Further, the line-of-sight setting unit 304 sets the specified intersection as the line-of-sight position 701 to the composition instruction support system 300. In this manner, the shooting user 103 can determine the line-of-sight position 701 by specifying one location in the metaverse space.

The straight line of the light-ray object 603 usually intersects the spherical surface of the hemispherical object 702 at two points, that is, a front point (a white X mark) and a back point (a black X mark). In this regard, the shooting user 103 can select one of the intersections of the hemispherical object 702 and the light-ray object 603 by a button operation of the controller 202. The hemispherical object 702 and the light linear ray object 603 are visible only to the shooting user 103 and are not visible in the shot image.

Returning to the description of FIG. 4. In a step S405, the CPU 211 displays, with the live view display unit 305, the live view 110 at the line-of-sight position 701 set in the step S404 (a second display step). Specifically, as illustrated in FIG. 7, the live view 110 is displayed in the metaverse space. At this time, the live view 110 is visible only to the object user 101 and the shooting user 103 as described above. This allows the object user 101 to adjust the own pose while viewing the live view 110. The live view display unit 305 arranges the live view 110 so as to be orthogonal to the line-of-sight in consideration of the height of the eyes of the object avatar 104 who is standing at the standing position 601 set in the step S402. This ensures the visibility of the live view 110.

The live view display unit 305 may display the user name of the object user 101 who is the target of the composition instruction near the live view 110 in the visual field of the shooting user 103 so as not to be shot in the shot image. Accordingly, the shooting user 103 can easily recognize that the live view 110 is displayed due to the composition instruction to the object user 101. The live view display unit 305 may move the live view 110 in conjunction with a change in the irradiation direction of the light-ray object 603.

Returning to the description of FIG. 4. In a step S406, the CPU 211 detects the pose of the shooting user 103 by the shooter pose detection unit 306 and sets it to the composition instruction support system 300 (a first detection step). In this regard, the user pose detection unit 306 continuously performs the body tracking to detect the pose of the shooting user 103 regardless of the process in the step S406. Therefore, in the step S406, the shooter pose detection unit 306 determines the current pose of the shooting user 103 detected by the body tracking in accordance with the GUI operation by the shooting user 103 and sets the pose to the composition instruction support system 300.

In a step S407, the CPU 211 generates, with the model pose display unit 307, a pose object of 3DCG as a model of the pose of the object avatar 104 based on the pose set in the step S406. Further, the model pose display unit 307 arranges and displays the generated pose object at the standing position 601 set in the step S402 (a third display step). Thereafter, the process of the flowchart in FIG. 4 ends.

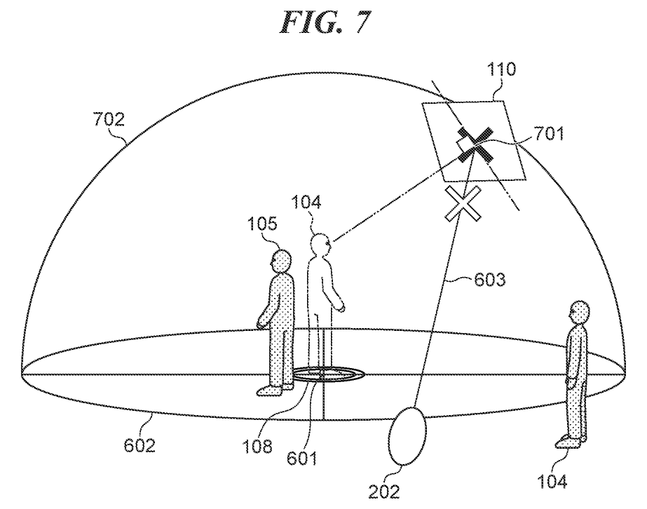

FIG. 8 is a view illustrating a pose object 801 from a viewpoint of a third party. In the case of FIG. 8, the shooter avatar 106 reflecting the current pose of the shooting user 103 is in a pose with the right hand raised, and the pose is set to the composition instruction support system 300. Therefore, the model pose display unit 307 generates an object avatar as the pose object 801 having the pose set in the composition instruction support system 300, that is, the same pose as the shooter avatar 106, separately from the original object avatar 104. Further, the model pose display unit 307 displays the generated pose object 801 at the standing position 601. Such display of the pose object 801 indicates the pose that the shooting user 103 expects for the object avatar 104 to the object user 101.

At this time, the pose object 801 is visible only to the object user 101 and the shooting user 103, and is not shot in the shot image. The model pose display unit 307 also adjusts the orientation of the pose object 801 so that the direction of the line-of-sight of the pose object 801 matches the direction of the live view 110 at the line-of-sight position 701 as much as possible. For example, the model pose display unit 307 adjusts positions of black eyes of the pose object 801 so that the line-of-sight of the pose object 801 is orthogonal to the live view 110 at the line-of-sight position 701 set in the step S404. The display of the pose object 801 in this manner indicates the pose that the shooting user 103 expects for the object avatar 104 to the object user 101 in accordance with the composition assumed by the shooting user 103. However, the position and orientation of the pose object 801 displayed may be any position and orientation that are not related to the standing position 601 and the line-of-sight position 701.

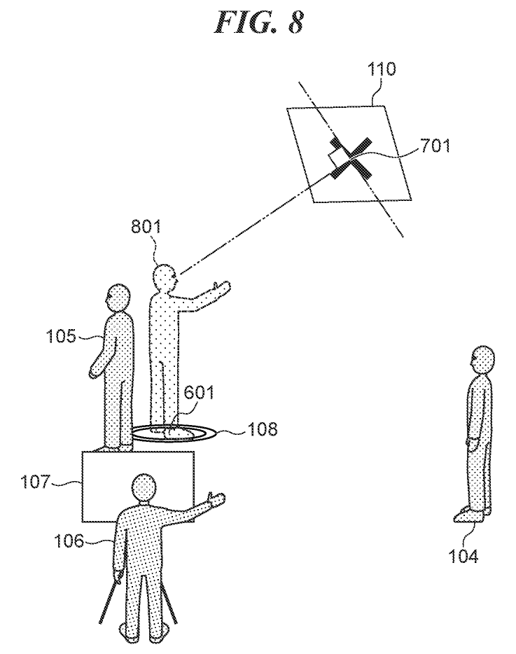

FIG. 9 is a view illustrating a visual field of the object user 101 when the composition instruction is issued. In the visual field of the object user 101, the shooter avatar 106 and the camera object 107 are positioned on the left side, and the object avatar 105 is positioned on the right side and slightly behind the camera object 107. Further, the standing position mark 108 is positioned on the floor surface on the right side and slightly before the object avatar 105, and the pose object 801 facing the live view 110 is positioned on the standing position mark 108.

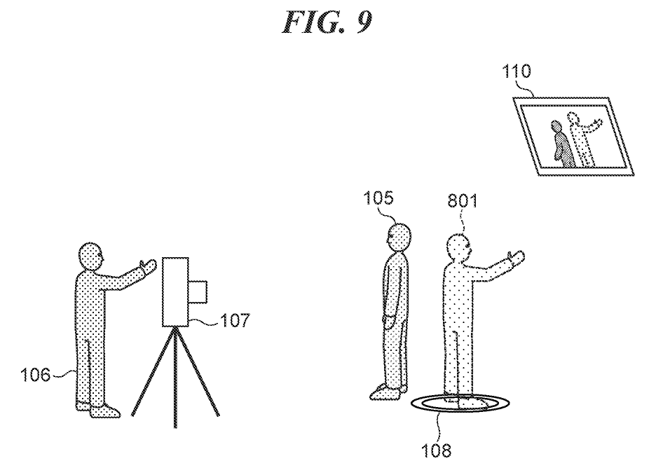

FIG. 10 is a view illustrating a visual field of the object user 101 when the object avatar 104 moves to the standing position 601 and faces the live view 110. In the visual field of the object user 101, the live view 110 is positioned substantially at the center thereof. In the live view 110, the pose object 801 is displayed in a superimposed manner on a real time image shot from the camera object 107 in the metaverse space. This allows the object user 101 to adjust own pose while viewing the pose object 801 in the live view 110.

As described above, the HMD 100 of the first embodiment can reliably transmit the standing position 601 in the shooting in the metaverse space, the line-of-sight position 701, and the composition instruction from the shooting user 103 regarding the pose to the object users 101 and 102.

Hereinafter, a second embodiment will be described with reference to FIGS. 11 to 13. In the second embodiment, a method of adjusting (including fine adjustment) the positions of the standing position marks 108 and 109 and the live views 110 and 111 after the first embodiment is performed will be described. In the second embodiment, differences from the first embodiment will be described. In the second embodiment, the same configurations as those of the first embodiment are denoted by the same reference numerals, and the description thereof will be omitted. FIG. 11 is a flowchart illustrating a process in adjusting the positions of the standing position marks 108 and 109 and the live views 110 and 111. The process of the flowchart in FIG. 11 is started when the shooting user 103 selects to adjust the positions of the standing position marks 108 and 109 and the live views 110 and 111 by a GUI operation as a trigger.

In a step S1101, the CPU 211 performs the following process with the mark/live-view setting unit 308. The mark/live-view setting unit 308 sets a position adjustment target selected by the shooting user 103 from among the standing position marks 108 and 109 displayed in the step S403 to the composition instruction support system 300. The mark/live-view setting unit 308 sets a position adjustment target selected by the shooting user 103 from among the live views 110 and 111 displayed in the step S405 to the composition instruction support system 300.

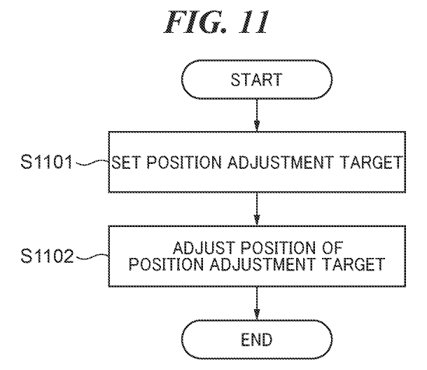

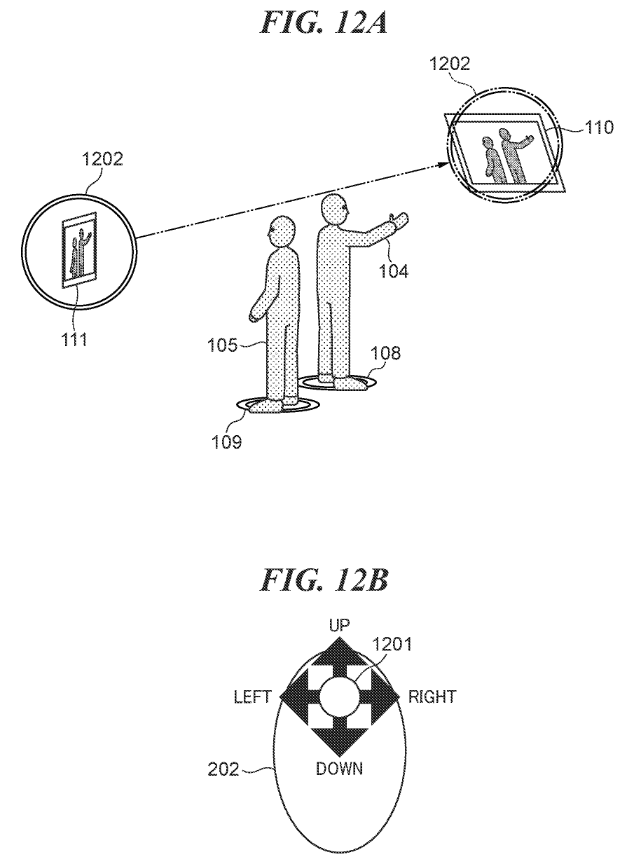

FIG. 12A is a view illustrating the metaverse space when the shooting user 103 selects the position adjustment target from among the standing position marks 108 and 109 and the live views 110 and 111 from the viewpoint of the shooting user 103. The shooting user 103 tilts a thumb stick 1201 of the controller 202 shown in FIG. 12B up, down, left, or right. Each time the thumb stick 1201 is tilted, a focus frame 1202 is shifted to one of the standing position marks 108 and 109 and the live views 110 and 111 that is located closest to the focus frame 1202 in the direction in which the thumb stick 1201 is tilted. At this time, the focus frame 1202 is visible only to the shooting user 103 and is not shot in the shot image.

In the case of FIG. 12A, the focus frame 1202 is at a position surrounding the live view 111. For example, if the thumb stick 1201 is tilted to the right, the focus frame 1202 will transition to a position surrounding the live view 110. Further, for example, if the thumb stick 1201 is tilted to the down, the focus frame 1202 will be shifted to a position surrounding the standing position mark 108. Further, for example, if the thumb stick 1201 is tilted to the left, the focus frame 1202 will be shifted to a position surrounding the standing position mark 109. Further, for example, if the thumb stick 1201 is tilted to the left, the focus frame 1202 will transition to a position surrounding the live view 111.

In this manner, the shooting user 103 selects one of the standing position marks 108 and 109 and the live views 110 and 111 by surrounding the one with the focus frame 1202 that can be shifted by the thumb stick 1201 of the controller 202. Further, when the shooting user 103 presses an OK button of the controller 202, one of the standing position marks 108 and 109 and the live views 110 and 111 surrounded by the focus frame 1202 is set as the position adjustment target.

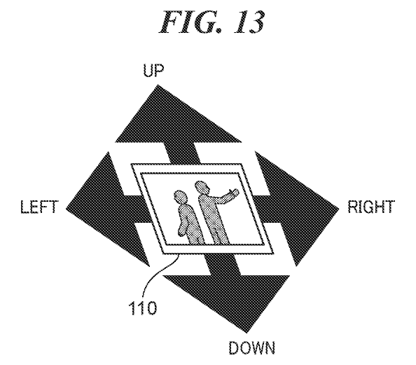

Returning to the description of FIG. 11. In a step S1102, the CPU 211 adjusts the position of the position adjustment target set in the step S1101 in the vertical and horizontal directions with the mark/live-view adjustment unit 309. Thereafter, the flowchart in FIG. 11 ends. FIG. 13 is a view for describing adjustment of the position of the live view 110 set as the position adjustment target. For example, each time the shooting user 103 tilts the thumb stick 1201 of the controller 202 to the up, the position of the live view 110 moves upward with respect to the horizontal plane of the live view 110. This point is the same even when the thumb stick 1201 of the controller 202 is tilted to the down, left, or right. In this manner, the shooting user 103 may adjust the position of the live view 110.

Thereafter, when the shooting user 103 presses the OK button of the controller 202, the mark/live-view adjustment unit 309 sets the current position of the live view 110 to the composition instruction support system 300. The live view 110 of which the position has been adjusted in this manner is displayed at the latest position with the live view display unit 305. In addition, in the visual fields of the shooting user 103 and the object user 101, the live view 110 is displayed so as to move to the up, down, left, or right little by little in response to the operation of the thumb stick 1201 of the controller 202 by the shooting user 103. This point is the same as in a case where the live view 111, the standing position mark 108, or the standing position mark 109 is set as the position adjustment target.

Note that the adjustment of the positions of the standing position marks 108 and 109 and the adjustment of the positions of the live views 110 and 111 may be separately selected by GUI operations by the shooting user 103. In this case, when the adjustment of the position of the standing position mark 108 or 109 is selected, the focus frame 1202 is shifted to the position surrounding the standing position mark 108 or the position surrounding the standing position mark 109. When the adjustment of the position of the live view 110 or 111 is selected, the focus frame 1202 is shifted to the position surrounding the live view 110 or the position surrounding the live view 111.

As described above, the HMD 100 of the second embodiment can be transmitted to the object users 101 and 102 while correcting the composition instruction from the shooting user 103 about the standing position 601 and the line-of-sight position 701 in the shooting in the metaverse space.

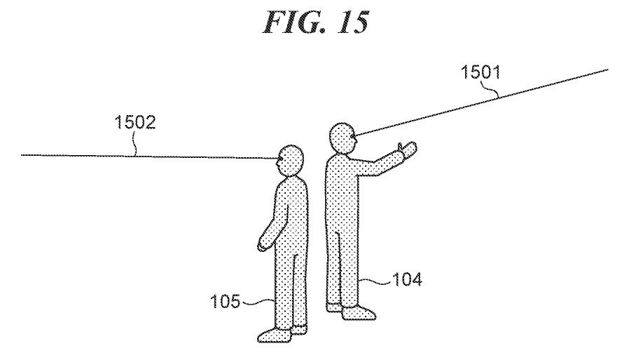

Hereinafter, a third embodiment will be described with reference to FIGS. 14 and 15. In the third embodiment, a method of displaying line-of-sights of the object avatars 104 and 105 will be described. In the third embodiment, a difference from the second embodiment will be described. In the third embodiment, the same configurations as those of the second embodiment are denoted by the same reference numerals, and the description thereof will be omitted.

FIG. 14 is a flowchart illustrating a process in displaying the line-of-sights of the object avatars 104 and 105. The flowchart in FIG. 14 is started when the shooting user 103 selects to display the line-of-sights of the object avatars 104 and 105 by a GUI operation as a trigger. Note that the process of the flowchart in FIG. 14 is performed on all image shooting objects in the metaverse space, that is, the object avatars 104 and 105. Therefore, the object line-of-sight detection unit 310 and the object line-of-sight display unit 311 related to the method of displaying the line-of-sights of the object avatars 104 and 105 are not directly connected to other units in the composition instruction support system 300 as shown in FIG. 3.

In a step S1401, the CPU 211 detects the line-of-sights of the object avatars 104 and 105 with the object line-of-sight detection unit 310. Further, the object line-of-sight detection unit 310 sets the detected line-of-sights of the object avatars 104 and 105 to the composition instruction support system 300. Since the line-of-sights of the object avatars 104 and 105 reflect the line-of-sights of the object users 101 and 102, the object line-of-sight detection unit 310 may detect the line-of-sights of the object avatars 104 and 105 from the tracking result of the eye tracking of the object users 101 and 102. In a step S1402, the CPU 211 displays the line-of-sights of the object avatars 104 and 105 set in the step S1401 in the metaverse space with the object line-of-sight display unit 311. Thereafter, the process of the flowchart in FIG. 14 ends. The line-of-sights of the object avatars 104 and 105 are continuously displayed until the shooting user 103 selects the end of the display by a GUI operation.

FIG. 15 is a view illustrating the metaverse space in which the line-of-sights of the object avatars 104 and 105 are displayed from the viewpoint of the shooting user 103. The object line-of-sight display unit 311 displays line-of-sight objects 1501 and 1502 as 3DCG objects in light-ray shapes indicating the line-of-sights of the object avatars 104 and 105 so as to go out from the eyes of the object avatars 104 and 105. At this time, the line-of-sight objects 1501 and 1502 are visible only to the shooting user 103 and are not shot in the shot image.

As described above, the HMD 100 of the third embodiment displays the line-of-sights of the object avatars 104 and 105. Accordingly, the shooting user 103 can accurately understand the line-of-sights of the object avatars 104 and 105, and thus, for example, the accuracy of adjustment of the positions of the live views 110 and 111 is improved.

Although the preferred embodiments of the present disclosure have been described above, the present disclosure is not limited to the above-described embodiments, and various modifications and changes can be made within the scope of the gist of the present disclosure. For example, the CPU 211 (an automatic shooting unit) in the HMD 100 may automatically shoot an image in the metaverse space when similarity between the pose object 801 and the object avatar 104 is equal to or greater than a threshold. Accordingly, the HMD 100 can shoot an image in the metaverse space at a timing at which the pose of the object avatar 104 matches the pose expected by the shooting user 103. The same applies to the object avatar 105. In addition, when both the similarity of the object avatar 104 and the similarity of the object avatar 105 are equal to or greater than the threshold, the shooting in the metaverse space may be automatically performed.

In each embodiment, the case where the present disclosure is applied to shooting in the VR metaverse space has been described. However, the present disclosure is also applicable to the shooting in a metaverse space of augmented reality (hereinafter referred to as “AR”) or mixed reality (hereinafter referred to as “MR”). In this case, the camera of the shooting user 103 is not a virtual camera like the camera object 107, but is a real camera that is built in or externally attached to the HMD 100. Therefore, a composite image in which CG of the metaverse space is superimposed on a shot image transmitted from the camera is displayed as the live views 110 and 111. In the AR or the MR, the positional relationship in the real space is reflected to that in the metaverse space as-is, and thus objects of the image shooting in the metaverse space are not the object avatars 104 and 105 but the object users 101 and 102 themselves. Therefore, the metaverse space of the AR or the MR is a space in which the virtual space is superimposed on the real space. In the AR or the MR, a video see-through method or an optical see-through method (including smart glasses) is used for the HMD 100 instead of a full-immersion method.

According to the present disclosure, the composition instruction from the shooting user in the shooting in the metaverse space can be reliably transmitted to the object user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159969, filed September 17, 2024, which is hereby incorporated by reference herein in its entirety.

WHAT IS CLAIMED IS:

1. An information processing apparatus comprising:
a memory device that stores a set of instructions; and
at least one processor that executes the set of instructions to:
allow a shooting user to set a target object user to be a target of a composition instruction from among one or more object user in shooting in a metaverse space;
allow the shooting user to set a standing position of an avatar of the target object user in the metaverse space; and
display a first mark at the standing position in the metaverse space that is visible to the shooting user and the target object user on their respective display units so as not to be shot in a shot image in the metaverse space.

2. The information processing apparatus according to claim 1, wherein the at least one processor executes instructions in the memory device to:
allow the shooting user to set a line-of-sight position of the avatar of the target object user in the metaverse space; and
display a second mark at the line-of-sight position in the metaverse space that is visible to the shooting user and the target object user on their respective display units so as not to be shot in a shot image in the metaverse space.

3. The information processing apparatus according to claim 2, wherein the at least one processor executes instructions in the memory device to:
allow the shooting user to select a position adjustment target from among the first mark and the second mark; and
allow the shooting user to adjust the position of the mark selected from among the first mark and the second mark in the metaverse space that is visible to the shooting user and the target object user on their respective display units.

4. The information processing apparatus according to claim 2, wherein the at least one processor executes instructions in the memory device to specify the line-of-sight position at an intersection of a hemispherical object centered around the standing position and a light-ray object that can be operated by the shooting user.

5. The information processing apparatus according to claim 2, wherein the at least one processor executes instructions in the memory device to display a live view of the shooting in the metaverse space as the second mark so as to be orthogonal to a line-of-sight of the avatar of the target object user who is standing at the standing position.

6. The information processing apparatus according to claim 2, wherein the at least one processor executes instructions in the memory device to display a live view of the shooting in the metaverse space as the second mark.

7. The information processing apparatus according to claim 2, wherein the at least one processor executes instructions in the memory device to display a user name of the target object user near the second mark so as not to be shot in a shot image in the metaverse space.

8. The information processing apparatus according to claim 1, wherein the at least one processor executes instructions in the memory device to specify the standing position at an intersection of a floor surface object indicating a floor surface in the metaverse space and a light-ray object that can be operated by the shooting user.

9. The information processing apparatus according to claim 1, wherein the at least one processor executes instructions in the memory device to display a user name of the target object user near the first mark so as not to be shot in shooting in the metaverse space.

10. The information processing apparatus according to claim 1, wherein the at least one processor executes instructions in the memory device to:
detect a pose of the shooting user;
display a pose object having the detected pose in the metaverse space that is visible to the shooting user and the target object user on their respective display units so as not to be shot in a shot image in the metaverse space.

11. The information processing apparatus according to claim 10, wherein the at least one processor executes instructions in the memory device to:
allow the shooting user to set a standing position of the avatar of the target object user in the metaverse space;
display the first mark at the standing position in the metaverse space that is visible to the shooting user and the target object user on the respective display units so as not to be shot in a shot image in the metaverse space.

12. The information processing apparatus according to claim 11, wherein the at least one processor executes instructions in the memory device to display the pose object at the standing position.

13. The information processing apparatus according to claim 10, wherein the at least one processor executes instructions in the memory device to:
allow the shooting user to set a line-of-sight position of the avatar of the target object user in the metaverse space; and
display a second mark at the line-of-sight position set in the metaverse space that is visible to the shooting user and the target object user on the respective display units so as not to be shot in a shot image in the metaverse space.

14. The information processing apparatus according to claim 13, wherein the at least one processor executes instructions in the memory device to match an orientation of the pose object to the line-of-sight position.

15. The information processing apparatus according to claim 13, wherein the at least one processor executes instructions in the memory device to display an image obtained by superimposing the pose object on a live view shot in the metaverse space as the second mark.

16. The information processing apparatus according to claim 10, wherein the at least one processor executes instructions in the memory device to automatically shoot an image in the metaverse space when similarity between the avatar of the target object user and the pose object is equal to or greater than a threshold.

17. The information processing apparatus according to claim 1, wherein the at least one processor executes instructions in the memory device to:
detect a line-of-sight of the avatar of the object user in the metaverse space; and
display a line-of-sight object indicating the line-of-sight detected in the metaverse space that is visible to the shooting user on a display unit so as not to be shot in a shot image in the metaverse space.

18. The information processing apparatus according to claim 1, wherein the metaverse space is based on virtual reality, augmented reality, or mixed reality.

19. The information processing apparatus according to claim 1, wherein the information processing apparatus is a head mounted display including a display unit.

20. A control method for an information processing apparatus, the control method comprising:
allowing a shooting user to set a target object user to be a target of a composition instruction from among one or more object user in shooting in a metaverse space;
allowing the shooting user to set a standing position of an avatar of the target object user in the metaverse space; and
displaying a first mark at the standing position in the metaverse space that is visible to the shooting user and the target object user on their respective display units so as not to be shot in a shot image in the metaverse space.

21. A non-transitory computer-readable storage medium storing a control program causing a computer to execute a control method for an information processing apparatus, the control method comprising:
allowing a shooting user to set a target object user to be a target of a composition instruction from among one or more object user in shooting in a metaverse space;
allowing the shooting user to set a standing position of an avatar of the target object user in the metaverse space; and
displaying a first mark at the standing position in the metaverse space that is visible to the shooting user and the target object user on their respective display units so as not to be shot in a shot image in the metaverse space.
